(19) United States
(12) Patent Application Publication
(10) Pub. No.: US 2026/0052431 A1
(43) Pub. Date: Feb. 19, 2026

(54) METHOD AND APPARATUS FOR CONFIGURING CANDIDATE PSCELL DURING CONDITIONAL HANDOVER IN NEXT-GENERATION MOBILE COMMUNICATION

(71) Applicant: Samsung Electronics Co., Ltd., Suwon-si, Gyeonggi-do (KR)

(72) Inventor: June HWANG, Suwon-si (KR)

(21) Appl. No.: 19/102,098

(22) PCT Filed: Jul. 12, 2023
(86) PCT No.: PCT/KR2023/009925

§ 371 Date: Feb. 7, 2025

(30) Foreign Application Priority Data
Aug. 10, 2022 (KR) 10-2022-0099773
Jun. 12, 2023 (KR) 10-2023-0074646

(51) Int. Cl. H04W 36/00; H04W 36/30

(52) U.S. Cl. CPC H04W 36/0016; H04W 36/30

(57) ABSTRACT

The present invention relates to a method of a first base station, comprising the steps of: determining whether or not to perform conditional handover (CHO) and conditional PSCell addition and change (CPAC) for a terminal; transmitting, to a candidate target base station of the CHO, a handover request message including an indicator for the CHO and an indicator regarding performance of the CPAC; receiving, from the candidate target base station, a handover response message including configuration information for performing the CPAC; and transmitting, to the terminal, on the basis of the configuration information, a radio resource control (RRC) reconfiguration message including conditional reconfiguration information for performing the CHO and the CPAC, wherein the conditional reconfiguration information includes a configuration for the candidate target base station and a configuration for each of at least one candidate secondary cell group related to the CPAC.

### TECHNICAL FIELD

The disclosure relates to an operation of a UE in a mobile communication system. More particularly, the disclosure relates to a technology for applying a specific secondary cell group configuration when a handover to a specific PCell is performed.

### BACKGROUND ART

A 5G mobile communication technology defines wide frequency bands to allow a fast transmission speed and a new service and can be implemented not only in a frequency band equal to or lower than 6 GHz (‘Sub 6 GHz’) such as 3.5 gigahertz (GHz) but also in ultra-high frequencies band (‘Above 6 GHz’) called a millimeter wave (mm Wave) such as 28 GHz and 39 GHz. Further, in the case of a 6G mobile communication technology called a system of beyond 5G, implementation in terahertz bands (for example, bands such as 95 GHz to 3 THz) is considered to achieve a transmission rate 50 times faster than the 5G mobile communication technology and ultra-low latency reduced to 1/10.

At the beginning of 5G mobile communication technology, for the purposes of supporting an ultra-wideband service (enhanced mobile broadband: eMBB) and services for ultra-reliable low-latency communications (URLLC) and massive machine-type communications (mMTC) and meeting performance requirements, the standardization has been progressed for beamforming for mitigating propagation path loss and increasing a propagation delivery distance in an ultra-high frequency band, massive multiple-input multiple-output (massive MIMO), supporting of various numerologies for efficiently using ultra-high frequency resources (operation of a plurality of subcarrier spacings and the like), the dynamic operation of slot formats, initial access technology for supporting multi-beam transmission and a broadband, the definition and operation of a bandwidth part (BWP), a new channel coding method such as a low density parity check (LDPC) code for large-capacity data transmission and a Polar code for high-reliable transmission of control information, L2 pre-processing, network slicing that provides a dedicated network specialized for a specific service, and the like.

Currently, the discussion on the improvement of initial 5G mobile communication technology and performance enhancement thereof is being conducted in consideration of services that the 5G mobile communication technology intended to support, and the physical layer standardization is being progressed for vehicle-to-everything (V2X) for helping an autonomous vehicle in driving determination, based on location and state information that the vehicle transmits, so as to increase convenience of the user, new radio unlicensed (NR-U) that aims at a system operation meeting requirements according to various regulations in an unlicensed band, NR UE low power consumption technology (UE power saving), a non-terrestrial network (NTN) corresponding to direct communication between the UE and a satellite for securing the coverage in an area in which communication with a terrestrial network is not possible, location measurement (positioning), and the like.

Further, the standardization is also being progressed for wireless interface architecture/protocol fields for technology such as an intelligent factory (industrial Internet of things (IIoT)) for supporting a new service through a link and convergence with other industrials, an integrated access and backhaul (IAB) that provides a node for expanding a network service area by integratively supporting a wireless backhaul link and an access link, mobility enhancement technology including conditional handover and dual active protocol stack (DAPS) handover, and 2-step random access (2-step RACH for NR) that simplifies a random access procedure, 5G baseline architecture (for example, service-based architecture or service-based interface) for grafting network function virtualization (NFV) on software-defined networking (SDN) technology, and system architecture/service fields for mobile edge computing (MEC) that receives a service, based on the UE location.

When the 5G mobile communication system is commercialized, connected devices which are growing explosively will be connected to a communication network, and accordingly, it is expected to enhance functions and performance of the 5G mobile communication system and need an integrated operation of the connected devices. To this end, new research is scheduled to be conducted on improvement of the performance and reduction in complexity for 5G using extended reality (XR) for efficiently supporting augmented reality (AR), virtual reality (VR), and mixed reality (MR), artificial intelligence (AI), and machine learning (ML), supporting of an AI service, supporting of a metaverse service, drone communication, and the like.

Further, the development of the 5G mobile communication system may be the foundation of the development of not only multi-antenna transmission technology such as a new waveform for securing the coverage in a terahertz band of 6G mobile communication technology, full dimensional multi input multi output (FD-MIMO), an array antenna, and a large scale antenna, a high-dimensional spatial multiplexing technology using metamaterial-based lens and antennas, and orbital angular momentum (OAM) in order to improve the coverage of signals in terahertz bands, and reconfigurable intelligent surface (RIS) technology, but also full duplex technology for improving the frequency efficiency of 6G mobile communication technology and enhancing the system network, AI-based communication technology that uses satellites and artificial intelligence (AI) from the design stage and internalize end-to-end AI supporting functions to realize system optimization, and next-generation distributed computing technology that realizes a service having complexity that exceeds the limits of UE calculation capability by using ultra-high performance communication and computing resources.

As described above, various services can be provided according to the development of the mobile communication system, so that a method of effectively providing the services is required. For example, the UE may perform conditional handover to a specific PCell. In this case, a separate delay may occur when multiple SCGs are established like the case where a secondary cell group (SCG) is added based on a changed master node (MN) or the existing SCG changes to another SCG.

### DISCLOSURE OF INVENTION

### Technical Problem

An aspect of the disclosure is to provide a method capable of making a PSCell change to a specific target secondary node without a separate signal after a specific condition is met even though a UE performs handover to a target master node as the target master node transfers configuration information received from multiple target secondary nodes to the UE in a wireless communication system.

### Solution to Problem

In a communication system according to an embodiment of the disclosure in order to solve the problem, a method of a first base station may include determining to perform a conditional handover (CHO) for a terminal and a conditional PSCell addition and change (CPAC), transmitting a handover request message including an indicator for the CHO and an indicator for performing the CPAC to a candidate target base station of the CHO, receiving a handover response message including configuration information for performing the CPAC from the candidate target base station, and based on the configuration information, transmitting a radio resource control (RRC) reconfiguration message including conditional reconfiguration information for performing the CHO and the CPAC to the terminal, wherein the conditional reconfiguration information includes a configuration for the candidate target base station and a configuration for each of at least one candidate secondary cell group related to the CPAC.

In a communication system according to an embodiment of the disclosure, a method of a second base station may include receiving a handover request message including an indicator for a conditional handover (CHO) related to a terminal and an indicator for performing a conditional PSCell addition and change (CPAC) from a first base station, transmitting a first message making a request for a configuration related to the performance of the CPAC to at least one candidate secondary cell group related to the CPAC, based on the handover request message, receiving a second message including the configuration related to the performance of the CPAC from the at least one candidate secondary cell group, and transmitting a handover response message including configuration information based on the configuration related to the performance of the CPAC to the first base station, wherein the configuration information is used to generate conditional reconfiguration information for performing the CHO for the terminal and the CPAC, and wherein the conditional reconfiguration information includes a configuration for a second base station and a configuration for each of the at least one candidate secondary cell group.

In a communication system according to an embodiment of the disclosure, a first base station may include a transceiver and a controller configured to determine to perform a conditional handover (CHO) for a terminal and a conditional PSCell addition and change (CPAC), control the transceiver to transmit a handover request message including an indicator for the CHO and an indicator for performing the CPAC to a candidate target base station of the CHO, control the transceiver to receive a handover response message including configuration information for performing the CPAC from the candidate target base station, and control the transceiver to transmit a radio resource control (RRC) reconfiguration message including conditional reconfiguration information for performing the CHO and the CPAC to the terminal, based on the configuration information, wherein the conditional reconfiguration information includes a configuration for the candidate target base station and a configuration for each of at least one candidate secondary cell group related to the CPAC.

In a communication system according to an embodiment of the disclosure, a second base station may include a transceiver and a controller configured to control the transceiver to receive a handover request message including an indicator for a conditional handover (CHO) related to a terminal and an indicator for performing a conditional PSCell addition and change (CPAC) from a first base station, control the transceiver to transmit a first message making a request for a configuration related to the performance of the CPAC to at least one candidate secondary cell group related to the CPAC, based on the handover request message, control the transceiver to receive a second message including the configuration related to the performance of the CPAC from the at least one candidate secondary cell group, and control the transceiver to transmit a handover response message including configuration information based on the configuration related to the performance of the CPAC to the first base station, wherein the configuration information is used to generate conditional reconfiguration information for performing the CHO for the terminal and the CPAC, and wherein the conditional reconfiguration information includes a configuration for a second base station and a configuration for each of the at least one candidate secondary cell group.

### Advantageous Effects of Invention

According to embodiments of the disclosure, there is an effect of guaranteeing a reliable connected state when the UE performs conditional handover and accesses a PSCell.

### BRIEF DESCRIPTION OF DRAWINGS

FIG. 1 is a diagram illustrating the structure of a general LTE system.

FIG. 2 is a diagram illustrating a wireless protocol structure of the general LTE system.

FIG. 3 is a diagram illustrating a structure of a next-generation mobile communication system according to an embodiment of the disclosure.

FIG. 4 is a diagram illustrating a wireless protocol structure of the next-generation mobile communication system according to an embodiment of the disclosure.

FIG. 5 is a block diagram illustrating an internal structure of a UE according to an embodiment of the disclosure.

FIG. 6 is a block diagram illustrating a configuration of an NR base station according to an embodiment of the disclosure.

FIG. 7 is a diagram illustrating a structure of a conditional reconfiguration field received by the UE.

FIG. 8A is a diagram illustrating an operation when an operation proposed in the disclosure is initially configured.

FIG. 8B is a diagram illustrating an operation when an operation proposed in the disclosure is initially configured.

FIG. 8C is a diagram illustrating an operation when an operation proposed in the disclosure is initially configured.

FIG. 9 is a diagram illustrating a procedure of, in response to a change in the current MCG configuration of an S-MN after conditional handover for a candidate SCG is initially configured in the UE, reflecting the corresponding configuration in CHO with candidate SCG configuration.

FIG. 10A is a diagram illustrating a required procedure when a T-SN desires to release the maintained candidate SCG after Cho with candidate SCG is initially configured.

FIG. 10B is a diagram illustrating a required procedure when the T-SN desires to release the maintained candidate SCG after Cho with candidate SCG is initially configured.

FIG. 11 is a diagram illustrating operations performed by the UE and the order thereof when RRCReconfiguration is received, and a problematic part in some steps.

### MODE FOR THE INVENTION

Hereinafter, the principle of operation of the disclosure will be described in detail with reference to the accompanying drawings. In describing the disclosure below, a detailed description of related known functions or configurations incorporated herein will be omitted when it is determined that the detailed description thereof may unnecessarily obscure the subject matter of the disclosure. The terms which will be used below are terms defined in consideration of the functions in the disclosure, and may differ according to users, intentions of users, or customs. Therefore, the definitions of the terms should be made based on the contents throughout the specification.

Terms for identifying access nodes used in the following description, terms referring to network entities, terms referring to messages, terms referring to interfaces between network entities, and terms referring to various pieces of identification information are used for convenience of description. Therefore, the disclosure is not limited to the terminologies provided below, and other terms that indicate subjects having equivalent technical meanings may be used.

Hereinafter, a base station is the entity that allocates resources to the UE, and may be at least one of a gNode B, an eNode B, a Node B, a base station (BS), a radio access unit, a base station controller, and a node on a network. The UE may include a user equipment (UE), a mobile station (MS), a cellular phone, a smart phone, a computer, and a multimedia system capable of performing a communication function. In the disclosure, downlink (DL) refers to a wireless transmission path of a signal which the BS transmits to the UE, and uplink (UL) refers to a wireless transmission path of a signal which the UE transmits to the BS. Further, hereinafter, an LTE or LTE-A system may be described as an example, but embodiments of the disclosure can be applied to other communications having a similar technical background or channel form. For example, 5G mobile communication technology (5G, new radio, or NR) developed after LTE-A may be included in systems to which the embodiments of the disclosure can be applied, and the 5G below may be the concept including the existing LTE and LTE-A, and similar other services. The disclosure can be applied to other communication systems through some modifications without departing from the scope of the disclosure on the basis of determination by those skilled in the art. It will be understood that each block of the flowchart illustrations and combinations of the flowchart illustrations can be implemented by computer program instructions.

These computer program instructions may be loaded onto a general-purpose computer, special-purpose computer, or processor of other programmable data-processing apparatuses, such that the instructions which execute on the computer or the processor of other programmable data-processing apparatuses create a means for implementing the functions specified in the flowchart block(s). These computer program instructions may also be stored in a computer-available or a computer-readable memory that can direct a computer or other programmable data-processing apparatus to implement a function in a particular manner such that the instructions stored in the computer-available or computer-readable memory produce an article of manufacture including an instruction means for implementing the function specified in the flowchart block(s). The computer program instructions may also be loaded onto a computer or other programmable data-processing apparatus to cause a series of operational steps to be performed on the computer or other programmable data-processing apparatus to produce a computer-implemented process such that the instructions executed on the computer or other programmable data-processing apparatus provide steps for implementing the functions specified in the flowchart block(s).

In this regard, each block may represent a module, segment, or portion of code, which includes one or more executable instructions for implementing the specified logical function(s). It should also be noted that, in some alternative implementations, the functions noted in the blocks may occur out of the order. For example, two blocks shown in succession may, in fact, be executed substantially concurrently, or the blocks may sometimes be executed in the reverse order, depending upon the functionality involved. The term “unit” (or “˜er”) used in the embodiments refers to a software or hardware component such as a field-programmable gate array (FPGA) or an application-specific integrated circuit (ASIC), and the “unit” (or “˜er”) may play roles. However, the “unit” (or “˜er”) is not limited to software or hardware. The “unit” (or “˜er”) may be configured to be present in an addressable storage medium, and may also be configured to run on one or more processors. Accordingly, for example, the “unit” (or “˜er”) includes software components, object-oriented software components, components such as class components and task components, processors, functions, attributes, procedures, subroutines, segments of program code, drivers, firmware, microcode, circuits, data, databases, data structures, tables, arrays, and parameters. Functions provided in the elements and the “unit” (or “˜er”) may be combined into a smaller number of elements and the units“ (or “˜ers”) or divided into a larger number of elements and “units” (or “˜ers”). In addition, the elements and the units” (or “˜ers”) may be implemented to run on one or more CPUs in a device or secure multimedia card. In embodiments, the units” (or “˜ers”) may include one or more processors. For convenience of description, the disclosure uses terms and names defined in 5GS and NR standards, which are the standards defined by the 3rd-generation partnership project (3GPP) among existing communication standards. However, the disclosure is not limited by the terms and names, and may be equally applied to a wireless communication network following another standard. For example, the disclosure may be applied to 3GPP 5GS/NR (5th generation mobile communication standard).

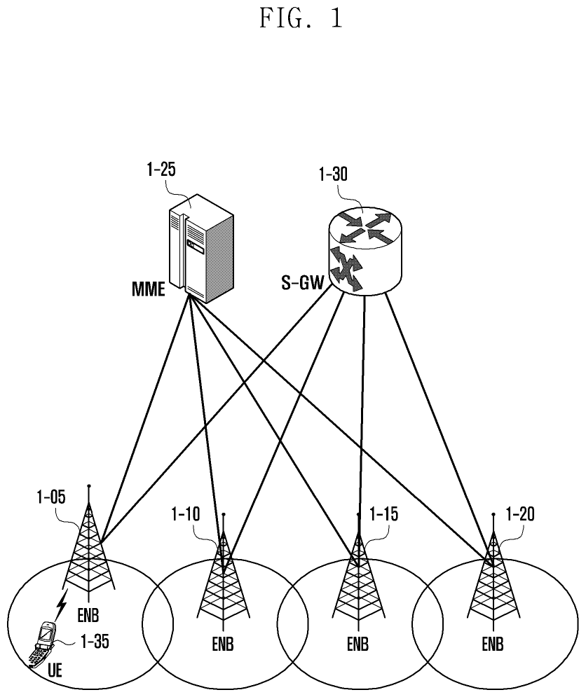

FIG. 1 is a diagram illustrating the structure of a general LTE system.

Referring to FIG. 1, as illustrated, a radio access network of the LTE system includes next-generation base stations (Evolved Node Bs (ENBs), Node Bs, or base stations) 1-05, 1-10, 1-15, and 1-20, a mobility management entity (MME) 1-25, and a serving gateway (S-GW) 1-30. A user terminal (hereinafter, referred to as a user equipment (UE) or a terminal) 1-35 may access an external network through the ENBs 1-05 to 1-20 and the S-GW 1-30.

In FIG. 1, the ENBs 1-05 to 1-20 may correspond to the conventional node Bs of a UMTS system. The ENB is connected to the UE 1-35 through a radio channel, and may perform a more complicated role than the conventional node B. In the LTE system, all user traffic including a real-time service such as a voice over IP (VOIP) through an Internet protocol may be served through a shared channel. Accordingly, a device for collecting and scheduling status information such as buffer statuses, available transmission power statuses, and channel statuses of UEs is needed, which is served by the ENBs 1-05 to 1-20. One ENB may generally control a plurality of cells. For example, in order to implement a transmission rate of 100 Mbps, the LTE system may use, for example, orthogonal frequency division multiplexing (OFDM) as the radio access technology in a bandwidth of 20 MHz.

Further, an adaptive modulation and coding (AMC) scheme of determining a modulation scheme and a channel coding rate in accordance with the channel status of the UE may be applied. The S-GW 1-30 is a device that provides a data bearer and may generate or remove a data bearer according to the control of the MME 1-25. The MME is a device that serves to perform various control functions as well as a function of managing mobility of the UE and may be connected to a plurality of ENBs.

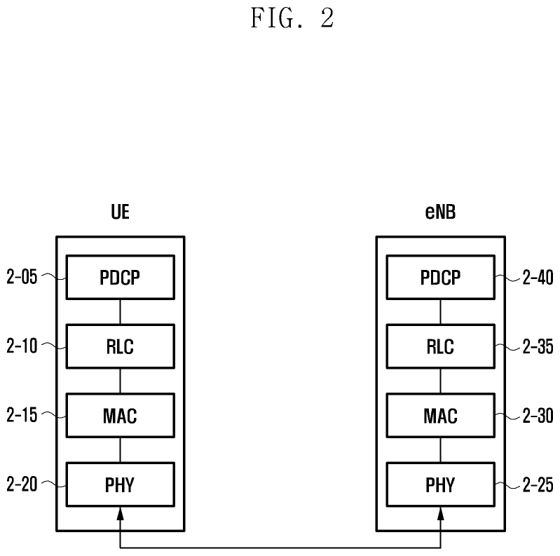

FIG. 2 is a diagram illustrating the wireless protocol structure of the conventional LTE system.

Referring to FIG. 2, the wireless protocol of the LTE system may include packet data convergence protocols (PDCPs) 2-05 and 2-40, radio link controls (RLCs) 2-10 and 2-35, medium access controls (MACs) 2-15 and 2-30, respectively, in UE and the ENB. The PDCP may perform an operation such as IP header compression/restoration. The main function of the PDCP may be summarized below.
Header compression and decompression function (Header compression and decompression: ROHC only)
User data transferring function (Transfer of user data)
Sequential delivery function (In-sequence delivery of upper layer PDUs at PDCP re-establishment procedure for RLC AM)
Sequence re-arrangement function (For split bearers in DC (only support for RLC AM): PDCP PDU routing for transmission and PDCP PDU reordering for reception)
Duplicate detection function (Duplicate detection of lower layer SDUs at PDCP re-establishment procedure for RLC AM)
Retransmission function (Retransmission of PDCP SDUs at handover and, for split bearers in DC, of PDCP PDUs at PDCP data-recovery procedure, for RLC AM)
Ciphering and deciphering function (Ciphering and deciphering)
Timer-based SDU removal function (Timer-based SDU discard in uplink)

The radio link controls (RLCs) 2-10 and 2-35 may perform an ARQ operation and the like by reconfiguring a PDCP packet data unit (PDU) in the proper size. The main function of the RLC may be summarized below.
Data transferring function (Transfer of upper layer PDUs)
ARQ function (Error Correction through ARQ (only for AM data transfer))
Concatenation, segmentation, and reassembly function (Concatenation, segmentation, and reassembly of RLC SDUs (only for UM and AM data transfer))
Re-segmentation function (Re-segmentation of RLC data PDUs (only for AM data transfer))
Reordering function (Reordering of RLC data PDUs (only for UM and AM data transfer)
Duplication detection function (Duplication detection (only for UM and AM data transfer))
Error detection function (Protocol error detection (only for AM data transfer))
RLC SDU deletion function (RLC SDU discard (only for UM and AM data transfer))
RLC re-establishment function (RLC re-establishment)

The MACs 2-15 and 2-30 are connected with various RLC layer entities constructed in one UE, and perform an operation for multiplexing RLC PDUs to the MAC PDU and de-multiplexing the RLC PDUs from the MAC PDU. The main function of the MAC may be summarized below.
Mapping function (Mapping between logical channels and transport channels)
Multiplexing and demultiplexing function (Multiplexing/demultiplexing of MAC SDUs belonging to one or different logical channels into/from Transport Blocks (TB) delivered to/from the physical layer on transport channels)
Scheduling information report function (Scheduling information reporting)
HARQ function (Error correction through HARQ)
Function of controlling priority between logical channels (Priority handling between logical channels of one UE)
Function of controlling priority between UEs (Priority handling between UEs by means of dynamic scheduling)
MBMS service identification function (MBMS service identification)
Transport format selection function (Transport format selection)
Padding function (Padding)

The PHY layers 2-20 and 2-25 perform an operation for channel-coding and modulating higher-layer data to generate an OFDM symbol and transmitting the OFDM symbol through a radio channel or demodulating and channel-decoding the OFDM symbol received through a radio channel and delivering the demodulated and channel-decoded OFDM symbol to a higher layer.

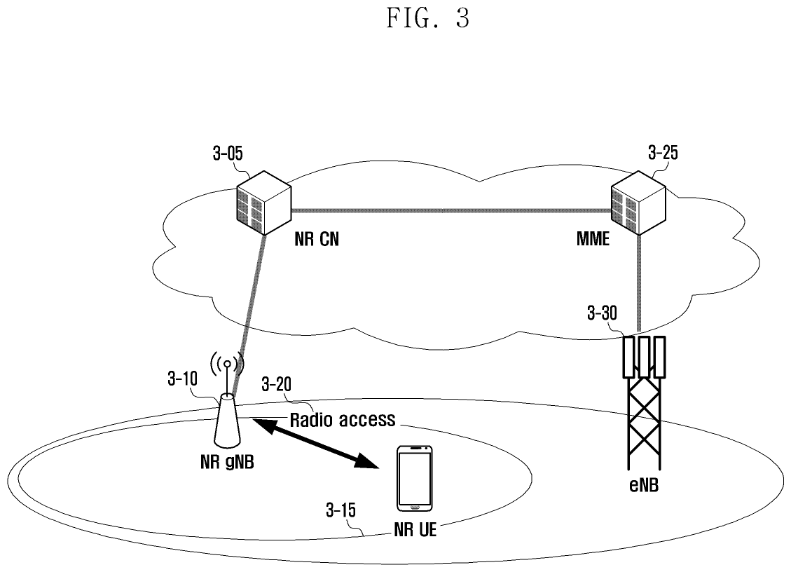

FIG. 3 is a diagram illustrating a structure of a next-generation mobile communication system.

Referring to FIG. 3, a radio access network of a next-generation mobile communication system (hereinafter, referred to as NR or 5g) may be constituted by a next-generation base station (new radio Node B, hereinafter, referred to as NR gNB, or NR base station) 3-10 and a next-generation radio core network (new radio core network or NR CN) 3-05. A next-generation radio user terminal (new radio user equipment, NR UE, or NR terminal) 3-15 may access an external network through the NR gNB 3-10 or the NR CN 3-05.

In FIG. 3, the NR gNB 3-10 may correspond to an evolved Node B (eNB) in a conventional LTE system. The NR gNB may be connected to the NR UE 3-15 through a radio channel and may provide better service than the conventional node B. In the next-generation mobile communication system, all user traffic may be served through a shared channel. Accordingly, a device for collecting and scheduling status information such as buffer statuses, available transmission power statuses, and channel statuses of UEs is needed, and the scheduling may be served by the NR gNB 3-10. On NR gNB 3-10 may control a plurality of cells. In the next-generation mobile communication system, in order to implement super-high data transmission compared to general LTE, a bandwidth higher than or equal to the normal maximum bandwidth may be applied. Further, a beamforming technology may be additionally grafted onto the orthogonal frequency division multiplexing (OFDM) as a radio access technology. In addition, an adaptive modulation and coding (AMC) scheme of determining a modulation scheme and a channel coding rate in correspondence to a channel status of the NR UE may be applied. The NR CN 3-05 may perform a function of supporting mobility, configuring a bearer, configuring QoS, and the like. The NR CN 3-05 is a device that performs various control functions as well as a function of managing mobility of the UE and may be connected with a plurality of NR gNBs. Further, the next-generation mobile communication system may be linked to the LTE system, and the NR CN 3-05 may be connected to an MME 3-25 through a network interface. The MME 3-25 may be connected to an eNB 3-30 that is the LTE base station.

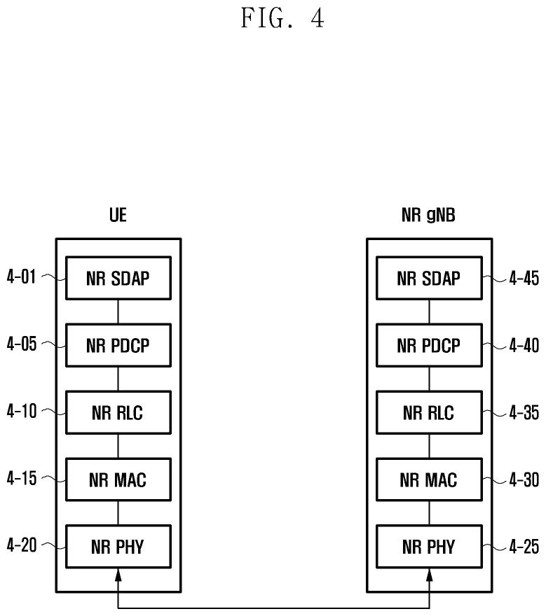

FIG. 4 is a diagram illustrating a wireless protocol structure of the next-generation mobile communication system to which the disclosure can be applied;

Referring to FIG. 4, the wireless protocol of the next-generation mobile communication system is constituted by NR service data adaptation protocols (SDAPs) 4-01 and 4-45, NR PDCPs 4-05 and 4-40, NR RLCs 4-10 and 4-35, NR MACs 4-15 and 4-30, and NR PHY 4-20 and 4-25 in the UE and the NR gNB.

Main functions of the NR SDAPs 4-01 and 4-45 may include some of the following functions.
User data transferring function (transfer of user-plane data)
Function of mapping QoS flow and a data bearer for uplink and downlink (mapping between a QoS flow and a DRB for both DL and UL)
Function of marking a QoS flow ID for uplink and downlink (marking QoS flow ID in both DL and UL packets)
Function of mapping reflective QoS flow to a data bearer for uplink SDAP PDUs (reflective QoS flow to DRB mapping for the UL SDAP PDUs)

For the SDAP layer entity, the UE may receive a configuration indicating whether to use the header of the SDAP layer entity or the function of the SDAP layer entity for each PDCP layer entity, each bearer, or each logical channel through a radio resource control (RRC) message. When the SDAP header is configured, the UE may indicate an update or a reconfiguration of mapping information for uplink and downlink QoS flow and the data bearer through a non-access stratum (NAS) quality of service (QoS) reflective configuration 1-bit indicator (NAS reflective QoS) and an access stratum (AS) QoS reflective configuration 1-bit indicator (AS reflective QoS) of the SDAP header. The SDAP header may include QoS flow ID information indicating the QoS. The QoS information may be used as data-processing-priority or scheduling information to support a seamless service.

Main functions of the NR PDCP 4-05 and 4-40 may include some of the following functions.
Header compression and decompression function (Header compression and decompression: ROHC only)
User data transferring function (Transfer of user data)
Sequential delivery function (In-sequence delivery of upper layer PDUs)
Non-sequential delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU removal function (Timer-based SDU discard in uplink)

In the above examples, the reordering function of the NR PDCP entity is a function of sequentially reordering PDCP PDUs received by a lower layer on the basis of a PDCP sequence number (SN). The reordering function of the NR PDCP entity may include a function of sequentially delivering reordered data to a higher layer, a function of directly performing delivery without consideration of the order, a function of performing reordering to record lost PDCP PDUs, a function of reporting statuses of the lost PDCP PDUs to a transmitting side, and a function of making a request for retransmitting the lost PDCP PDUs.

Main functions of the NR RLCs 4-10 and 4-35 may include some of the following functions.
Data transferring function (Transfer of upper layer PDUs)
Sequential delivery function (In-sequence delivery of upper layer PDUs)
Non-sequential delivery function (Out-of-sequence delivery of upper layer PDUs)
ARQ function (Error correction through ARQ)
Concatenation, segmentation, and reassembly function (Concatenation, segmentation, and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU deletion function (RLC SDU discard)
RLC re-establishment function (RLC re-establishment)

In the above description, the sequential delivery function (in-sequence delivery) of the NR RLC entity may be a function of sequentially delivering RLC SDUs received from a lower layer to a higher layer. When one RLC SDU is divided into a plurality of RLC SDUs and received, the sequential delivery function (in-sequence delivery) of the NR RLC entity may include a function of reassembling and then delivering the RLC SDUs.

The sequential delivery function (in-sequence delivery) of the NR RLC entities may include a function of reordering the received RLC PDUs, based on an RLC sequence number (SN) or a PDCP sequence number (SN), a function of performing reordering to record lost RLC PDUs, a function of reporting statuses of the lost RLC PDUs to a transmitting side, and a function of making a request for retransmitting the lost RLC PDUs.

The sequential delivery function (in-sequence delivery) of the NR RLC entity may include a function of, if there is a lost RLC SDU, sequentially delivering only RLC SDUs preceding the lost RLC SDU to the higher layer.

The sequential delivery function (in-sequence delivery) of the NR RLC entity may include a function of, if a predetermined timer expires even though there are lost RLC SDUs, sequentially delivering all RLC SDUs received before the timer starts to the higher layer.

The sequential delivery function (in-sequence delivery) of the NR RLC entity may include may include a function of, if a predetermined timer expires even though there are lost RLC SDUs, sequentially delivering all RLC SDUs received up to now to the higher layer.

The NR RLC entity may process RLC PDUs in the order of reception regardless of sequence numbers (out-of-sequence delivery) and deliver the RLC PDUs to the NR PDCP entity.

When receiving segments, the NR RLC entity may receive segments stored in the buffer or to be received in the future, reconfigure the segments to be one complete RLC PDU, and then deliver the RLC PDU to the NR PDCP entity.

The NR RLC layer may not include a concatenation function, and the function may be performed by the NR MAC layer, or may be replaced with a multiplexing function of the NR MAC layer.

In the above description, the non-sequential delivery function (out-of-sequence delivery) of the NR RLC entity may be a function of directly delivering RLC SDUs received from the lower layer to the higher layer regardless of the sequence. When one RLC SDU is divided into a plurality of RLC SDUs and received, the non-sequential delivery function (out-of-sequence delivery) of the NR RLC entity may include a function of reassembling and then delivering the RLC SDUs. The non-sequential delivery function (out-of-sequence delivery) of the NR RLC entity may include a function of storing RLC SNs or PDCP SNs of the received RLC PDUS, ordering the same, and recording lost RLC PDUs.

The NR MACs 4-15 and 4-30 may be connected to a plurality of NR RLC layer entities configured in one UE and main functions of the NR MAC may include some of the following functions.
Mapping function (Mapping between logical channels and transport channels)
Multiplexing and demultiplexing function (Multiplexing/demultiplexing of MAC SDUs)
Scheduling information report function (Scheduling information reporting)
HARQ function (Error correction through HARQ)
Function of controlling priority between logical channels (Priority handling between logical channels of one UE)
Function of controlling priority between UEs (Priority handling between UEs by means of dynamic scheduling)
MBMS service identification function (MBMS service identification)
Transport format selection function (Transport format selection)
Padding function (Padding)

The NR PHY layers 4-20 and 4-25 perform an operation for channel-coding and modulating higher layer data to generate an OFDM symbol and transmitting the OFDM symbol through a radio channel or demodulating and channel-decoding the OFDM symbol received through the radio channel and delivering the demodulated and channel-decoded OFDM symbol to the higher layer.

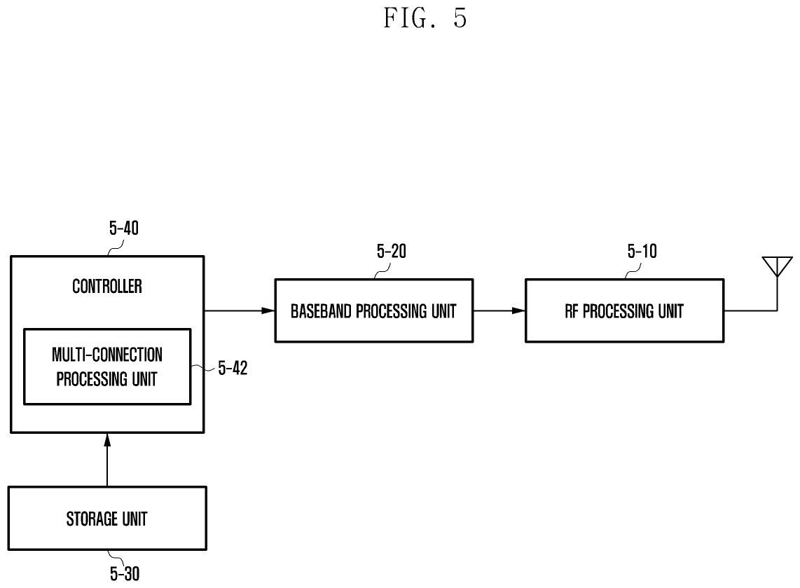

FIG. 5 is a block diagram illustrating the structure of a UE according to an embodiment of the disclosure.

Referring to FIG. 5, the UE includes a radio-frequency (RF) processing unit 5-10, a baseband processing unit 5-20, a storage unit 5-30, and a controller 5-40.

The RF processing unit 5-10 performs a function of transmitting and receiving a signal through a radio channel such as converting or amplifying a band of the signal. That is, the RF processing unit 5-10 up-converts a baseband signal provided from the baseband processing unit 5-20 into an RF band signal, transmits the RF band signal through an antenna, and then down-converts the RF band signal received through the antenna into a baseband signal. For example, the RF processing unit 5-10 may include a transmission filter, a reception filter, an amplifier, a mixer, an oscillator, a digital-to-analog converter (DAC), an analog-to-digital converter (ADC), and the like. Although only one antenna is illustrated in the drawing, the UE may include a plurality of antennas. The RF processing unit 5-10 may include a plurality of RF chains. Moreover, the RF processing unit 5-10 may perform beamforming. For the beamforming, the RF processing unit 5-10 may control a phase and a size of each of the signals transmitted/received through a plurality of antennas or antenna elements. The RF processing unit may perform MIMO and receive a plurality of layers when performing the MIMO operation.

The baseband processing unit 5-20 performs a function for conversion between a baseband signal and a bitstream according to a physical layer standard of the system. For example, in data transmission, the baseband processing unit 5-20 generates complex symbols by encoding and modulating a transmission bitstream. Further, in data reception, the baseband processing unit 5-20 reconstructs a reception bitstream by demodulating and decoding a baseband signal provided from the RF processing unit 5-10. For example, in an orthogonal frequency division multiplexing (OFDM) scheme, when data is transmitted, the baseband processing unit 5-20 generates complex symbols by encoding and modulating a transmission bitstream, mapping the complex symbols to subcarriers, and then configures OFDM symbols through an inverse fast Fourier transform (IFFT) operation and a cyclic prefix (CP) insertion. Further, when data is received, the baseband processing unit 5-20 divides the baseband signal provided from the RF processing unit 5-10 in the unit of OFDM symbols, reconstructs the signals mapped to the subcarriers through a fast Fourier transform (FFT) operation, and then reconstructs a reception bitstream through demodulation and decoding.

The baseband processing unit 5-20 and the RF processing unit 5-10 transmit and receive signals as described above. Accordingly, the baseband processing unit 5-20 and the RF processing unit 5-10 may be referred to as transmitters, receivers, transceivers, or communication units. At least one of the baseband processing unit 5-20 and the RF processing unit 5-10 may include a plurality of communication modules in order to support a plurality of different radio access technologies. Further, at least one of the baseband processing unit 5-20 and the RF processing unit 5-10 may include different communication modules in order to process signals in different frequency bands. For example, the different radio access technologies may include a wireless LAN (for example, IEEE 802.11) and a cellular network (for example, LTE). Further, the different frequency bands may include a super high frequency (SHF) (for example, 2.NRHz, NRhz) band and a millimeter (mm) wave (for example, 60 GHz) band.

The storage unit 5-30 stores data such as a basic program, an application, configuration information, and the like for the operation of the UE. Particularly, the storage unit 5-30 may store information related to a second access node performing wireless communication through a second radio access technology. The storage unit 5-30 provides stored data according to a request from the controller 5-40.

The controller 5-40 controls the overall operation of the UE. For example, the controller 5-40 transmits and receives signals through the baseband processing unit 5-20 and the RF processing unit 5-10. Further, the controller 5-40 records data in the storage unit 5-30 and reads the data. To this end, the controller 5-40 may include at least one processor. For example, the controller 5-40 may include a communication processor (CP) that performs a control for communication, and an application processor (AP) that controls a higher layer such as an application.

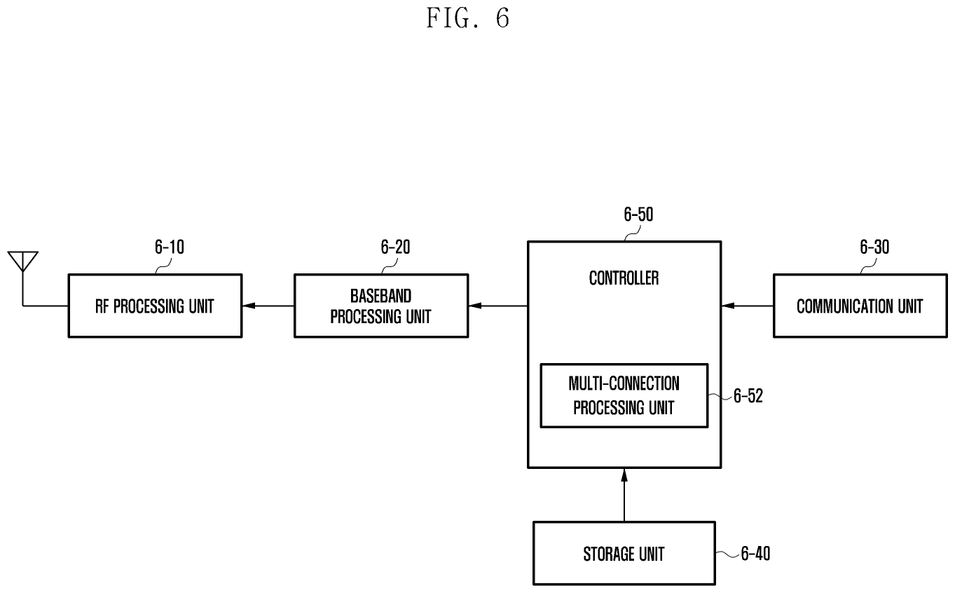

FIG. 6 is a block diagram illustrating the configuration of an NR base station according to an embodiment of the disclosure.

As illustrated in FIG. 6, the base station includes and is constituted by an RF processing unit 6-10, a baseband processing unit 6-20, a backhaul communication unit 6-30, a storage unit 6-40, and a controller 6-50.

The RF processing unit 6-10 performs a function of transmitting and receiving a signal through a radio channel such as converting or amplifying a band of the signal. The RF processing unit 6-10 up-converts a baseband signal provided from the baseband processing unit 6-20 into an RF band signal, transmits the RF band signal through an antenna, and then down-converts the RF band signal received through the antenna into a baseband signal. For example, the RF processing unit 6-10 may include a transmission filter, a reception filter, an amplifier, a mixer, an oscillator, a DAC, and an ADC. Although only one antenna is illustrated in the drawing, the first access node may include a plurality of antennas. The RF processing unit 6-10 may include a plurality of RF chains. The RF processing unit 6-10 may perform beamforming. For the beamforming, the RF processing unit 6-10 may control the phase and the size of each of the signals transmitted and received through a plurality of antennas or antenna elements. The RF processing unit may perform a downlink MIMO operation by transmitting one or more layers.

The baseband processing unit 6-20 performs a function for conversion between a baseband signal and a bitstream according to a physical layer standard of the first radio access technology. For example, when data is transmitted, the baseband processing unit 6-20 generates complex symbols by encoding and modulating a transmission bitstream. Further, when data is received, the baseband processing unit 6-20 reconstructs a reception bitstream by demodulating and decoding a baseband signal provided from the RF processing unit 6-10. For example, in an OFDM scheme, when data is transmitted, the baseband processing unit 6-20 may generate complex symbols by encoding and modulating the transmission bitstream, map the complex symbols to subcarriers, and then configure OFDM symbols through an IFFT operation and CP insertion. Further, when data is received, the baseband processing unit 6-20 divides the baseband signal provided from the RF processing unit 6-10 in the unit of OFDM symbols, reconstructs the signals mapped to the subcarriers through a FFT operation, and then reconstructs the reception bitstream through demodulation and decoding. The baseband processing unit 6-20 and the RF processing unit 6-10 transmit and receive signals as described above. Accordingly, the baseband processing unit 6-20 and the RF processing unit 6-10 may be referred to as transmitters, receiver, transceivers, communication units, or wireless communication units.

The backhaul communication unit 6-30 provides an interface for communicating with other nodes within the network. The backhaul communication unit 6-30 converts bitstream transmitted from the main base station to another node, for example, an auxiliary base station, a core network, or the like into a physical signal and converts a physical signal received from the other node into a bitstream.

The storage unit 6-40 stores data such as basic program, an application, and configuration information for the operation of the main base station. Particularly, the storage unit 6-40 may store information on bearers allocated to the accessed UE, a measurement result reported from the accessed UE, and the like. Further, the storage unit 6-40 may store information which is a reference for determining whether to provide or stop multiple connections to the UE. The storage unit 6-40 provides stored data according to a request from the controller 6-50.

The controller 6-50 controls overall operations of the base station. For example, the controller 6-50 transmits and receives signals through the baseband processing unit 6-20 and the RF processing unit 6-10 or through the backhaul communication unit 6-30. Further, the controller 6-50 records data in the storage unit 6-40 and reads the data. To this end, the controller 6-50 may include at least one processor.

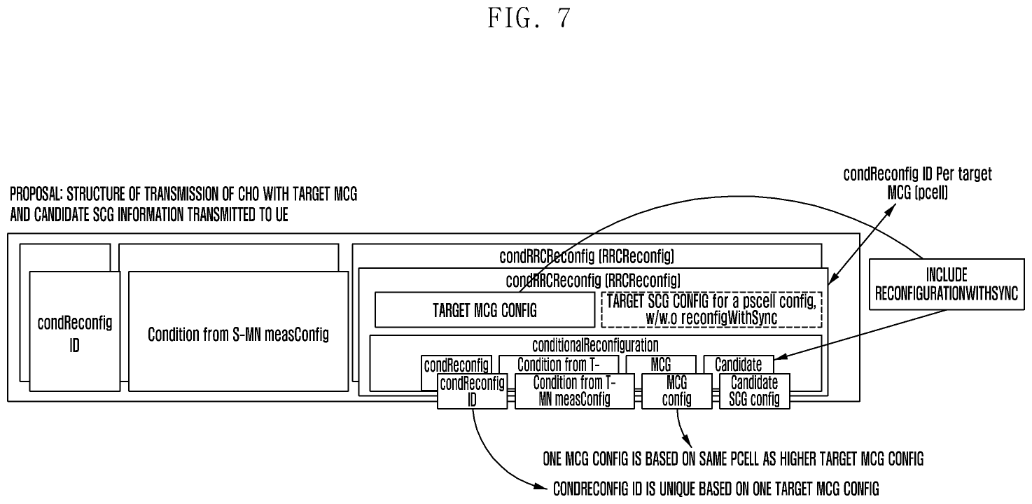

In the disclosure, when performing conditional primary cell (PCell) handover, the UE may receive a RRCReconfiguration message including a conditional reconfiguration field having the following structure from the network. Hereinafter, the description is made with reference to FIG. 7.

FIG. 7 is a diagram illustrating a structure of a conditional reconfiguration field received by the UE.

The conditional reconfiguration field has a list structure, and one entry of the list is constituted by a condReconfiguration identity (Id), a condition, and a RRCReconfiguration message which the UE should apply when the corresponding condition is met. Each element is described below.
Here, the condReconfiguration Id is made/allocated by a source-master node (S-MN). Each condition is associated with the RRCReconfiguration message to be applied when the condition is met. Every Id should be unique for each target master cell group (MCG).
The condition is made by the S-MN and is expressed as a measurement Id corresponding to the corresponding condition in measurement configuration information configured in the UE by the S-MN. Accordingly, the S-MN should implement a measurement Id, a measurement object, and a report configuration corresponding to the ID in the measurement configuration and configure the same in the UE.
RRCReconfiguration is made by a target-master mode (T-MN). This is constituted by a target MCG configuration, a target secondary cell group (SCG) configuration, and an internal conditional reconfiguration field. Each part may have the following description.
The target MCG configuration is made by the T-MN in accordance with a specific PCell. PCells, that is, MCGs for a specific T-MN may also be multiple. Further, T-MNs may also be multiple MNs. This includes a reconfiguration WithSync field.
The target SCG configuration is made to be directly applied by a specific target-secondary node (T-SN) when conditional handover (CHO) is performed in accordance with a specific primary secondary cell (PSCell) among its own cells, based on the target MCG. Here, the reconfiguration WithSync field may be or may not be included. For example, when the reconfiguration WithSync field is included in the target SCG configuration, a new SCG may be directly applied, and when the reconfiguration WithSync field is not included, the reconfiguration WithSync field may be used to update the current SCG configuration
An internal conditional reconfiguration field is written by the T-MN. The conditional reconfiguration field has a list structure, and one entry of the list is constituted by a condReconfiguration Id, a condition, and a RRCReconfiguration message which the UE should apply when the corresponding condition is met. Each element is described below.
The condReconfig ID is made/allocated by the T-MN. Each condition is associated with the RRCReconfiguration message to be applied when the condition is met. For each specific T-MN or each target MCG, the Id should be unique.
The condition is determined by the T-MN. The condition is expressed as a measurement Id corresponding to the corresponding condition in measurement configuration information configured in the UE by the T-MN. Accordingly, the T-MN should implement a measurement Id, a measurement object, and a report configuration corresponding to the ID in the measurement configuration and configure the same in the transmitted target MCG configuration.
RRCReconfiguration is constituted by a target MCG configuration and one specific candidate SCG configuration information. The target MCG configuration is a configuration based on a target MCG existing in RRCReconfiguration of the external conditional reconfiguration field or based on a target PCell. The candidate SCG config may include a reconfiguration WithSync field.

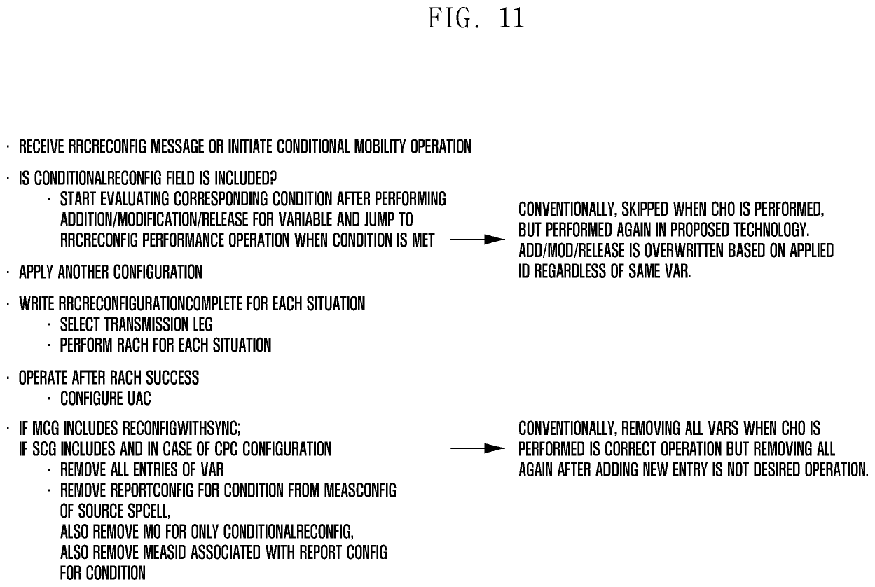

The UE receiving the RRCReconfiguration message including the external conditional reconfiguration from the S-MN may configure an id, a condition, and condRRCReconfig (that is, RRCReconfiguration message) as respective entries and store the entries in the UE variable. Further, the UE may start measurement for the relevant condition and start a condition evaluation. When one of the conditions of the external conditional reconfiguration is met, condRRCReconfig associated therewith is applied. At this time, when the operation of the existing RRC standard is performed, the following problem may occur. In connection with this, more detailed description is made with reference to FIG. 11 below.

The operation in which the UE applies RRCReconfiguration is sequentially performed as follows.
1) Apply specific configuration
2) Identify whether the conditional reconfiguration is included in RRCReconfiguration and, when it is included, perform a given conditional Reconfiguration entry add/modification/release operation for a UE variable and then start evaluating the corresponding condition, and when the condition is met, jump back to the RRCReconfig performance operation\
3) Apply specific configuration
4) Write RRCReconfigurationComplete
5) Operation after random access channel (RACH) success
6) When the MCG or the SCG includes reconfiguration WithSync, remove all entries of the UE variable, remove reportconfig for the condition from measConfig of a source SPCell (special cell), remove measurement object (MO) for only conditional Reconfig, and remove reportconfig for the condition and measId associated therewith

Conventionally, another conditional reconfiguration field could not be included in the conditional reconfiguration. Accordingly, only when the UE receives the conditional reconfiguration from the network, step 2) was performed (when CHO/conditional PSCell addition and change (CPAC) is performed, the operation of applying RRCReconfiguration is performed again, but step 2) was skipped in this case). However, according to this proposal, when another conditional reconfiguration field is stored in the conditional reconfiguration field, step 2) should be performed again if CHO/CPAC is performed. Accordingly, as a new add/modify/release operation is performed for the variable in which the existing entry currently operated by the UE is stored, the cond Reconfig ID may have the same value, and unnecessary existing conditional reconfiguration entries and the new entry are mixed later. Further, since even all entries that were just added are removed in step 6), information which the UE should maintain is also removed.

As solutions to this, three methods are possible.

Opt 1. It is assumed that removing the content of the UE variable in existing step 6) does not influence new storage of conditional reconfiguration information since fulfilled condRRCReconfig has been already temporarily stored in an internal UE buffer during a reconfiguration application process and the value is used to apply the RRC reconfiguration.

In this case, during step 2), a process may be introduced to perform separation, based on information indicating whether CHO/CPAC is performed, when the RRCReconfiguration application is not for performing CHO/CPAC, perform the add/modify/release operation of the existing conditional Reconfiguration UE variable and the target cell monitoring and HO execution operation, then perform an operation according to all other existing RRCReconfiguration application orders, and remove the UE variable and relevant measurement configuration information, and when the RRCReconfiguration application is for performing CHO/CPAC, add/modify/release entries of the corresponding conditional reconfiguration for the UE variable, monitor a target cell (in this case, a candidate PSCell) and evaluate a condition, and when the condition is met, perform CPAC.

The corresponding operation is as follows.

When the condition (condition of the external conditional reconfiguration written by the S-MN) of CHO is met, the operation according to section 5.3.5.3 of RRC standard (TS 38.331) starts.
1) Apply specific configuration
2) Identify whether a conditional reconfiguration is included in RRCReconfiguration and, when the RRCReconfiguration application is not for applying the conditional reconfiguration, perform a given conditional reconfiguration entry add/modification/release operation for the UE variable and then start evaluating the corresponding condition, and when it is determined that the condition is met, jump back to the RRCReconfig performance operation step
3) Apply specific configuration
4) Write RRCReconfigurationComplete
5) Operate after RACH success
6) When the MCG or the SCG includes reconfiguration WithSync, remove all entries of the UE variable, remove reportconfig for the condition from measConfig of a source spcell, also remove MO for only conditional Reconfig, and remove reportconfig for the condition and measId associated therewith
7) Identify whether a conditional reconfiguration is included in RRCReconfiguration and, when the RRCReconfiguration application is for applying the conditional reconfiguration, perform a given conditional reconfiguration entry add/modification/release operation for the UE variable and then start evaluating the corresponding condition, and when it is determined that the condition is met, jump back to the RRCReconfig performance operation step
Start (5.3.5.3
Skipped
1> if the RRCReconfiguration message includes the conditionalReconfiguration, and to apply this RRCReconfiguration is not for conditionalReconfiguration execution:
2> perform conditional reconfiguration as specified in 5.3.5.13; (that is, add/mod/release, target cell monitoring, and execution)
The rest is the same and skipped
Write complete msg/perform RACH success
If reconfig withSync is included,
remove the entry of the existing UE Var and remove measId
1. If the RRCReconfiguration message includes the conditionalReconfiguartion, and to apply this RRCReconfiguration is for conditionalReconfiguration execution:
2> perform conditional reconfiguration as specified in 5.3.5.13
)
Opt 2.

Internal conditional reconfiguration-related information is separately added/modified/released using a new UE Var, the corresponding target cell is monitored, and the condition is evaluated. The corresponding operation is as follows.

When the condition (condition written by the S-MN in the external conditional reconfiguration) of CHO is met, section 5.3.5.3 of RRC standard starts.
1) Apply specific configuration
2) Identify whether a conditional reconfiguration is included in RRCReconfiguration and, when the RRCReconfiguration application is not for applying the conditional reconfiguration, perform a given conditional reconfiguration entry add/modification/release operation for the UE variable and then start evaluating the corresponding condition, and when it is determined that the condition is met, jump back to the RRCReconfig performance operation step
2-1) Identify whether a conditional reconfiguration is included in RRCReconfiguration and, when the RRCReconfiguration application is for applying the conditional reconfiguration, perform a given conditional reconfiguration entry add/modification/release operation for a UE variable and then start evaluating the corresponding condition, and when it is determined that the condition is met, jump back to the RRCReconfig performance operation step
3) Apply specific configuration
4) Write RRCReconfigurationComplete
5) Operate after RACH success
6) When the MCG or the SCG includes reconfiguration WithSync, remove all entries of the UE variable, remove reportconfig for the condition from measConfig of a source spcell, also remove MO for only conditional Reconfig, and remove reportconfig for the condition and measId associated therewith
Start (5.3.5.3
Skipped
1> if the RRCReconfiguration message includes the conditionalReconfiguration, and to apply this RRCReconfiguration is not for conditionalReconfiguration execution:
2> perform conditional reconfiguration as specified in 5.3.5.13; (that is, add/mod/release, target cell monitoring, and execution)
1. If the RRCReconfiguration message includes the conditionalReconfiguartion, and to apply this RRCReconfiguration is for conditional Reconfiguration execution:
2> perform conditional reconfiguration as specified in 5.3.5.13 to new UE Variable CPAC;
The rest is the same and skipped
Write complete msg/perform RACH success
If reconfig withSync is included,
Remove the entry of the existing UE Var and remove measId
)

Opt 3. The remaining entries except for the entry including RRCReconfiguration that should be applied to the operation of removing the entry of the existing UE variable are removed, necessary work is performed, and then the rest is removed. The following description is an operation corresponding thereto.

When the condition (condition of the external conditional reconfiguration written by the S-MN) of CHO is met, section 5.3.5.3 of RRC standard starts.
1) Apply specific configuration
2) Identify whether a conditional reconfiguration is included in RRCReconfiguration and, when the RRCReconfiguration application is not for applying the conditional reconfiguration, perform a given conditional reconfiguration entry add/modification/release operation for the UE variable and then start evaluating the corresponding condition, and when it is determined that the condition is met, jump back to the RRCReconfig performance operation step
3) Apply specific configuration
4) Write RRCReconfigurationComplete
5) Operate after RACH success
6) When the MCG or the SCG includes reconfiguration WithSync, remove all entries of the UE variable except for an entry corresponding to currently applied RRCReconfiguration, remove reportconfig for the condition from measConfig of a source spcell, also remove MO for only conditional Reconfig, and remove reportconfig for the condition and measId associated therewith
7) Identify whether a conditional reconfiguration is included in RRCReconfiguration and, when the RRCReconfiguration application is for applying the conditional reconfiguration, perform a given conditional reconfiguration entry add/modification/release operation for the UE variable and then start evaluating the corresponding condition, and when it is determined that the condition is met, jump back to the RRCReconfig performance operation step
8) Remove the entry corresponding currently applied RRCReconfiguration from the UE variable
Start (5.3.5.3
Skipped
1> if the RRCReconfiguration message includes the conditionalReconfiguration, and this RRCReconfiguration is not for conditionalReconfiguration execution:
2> perform conditional reconfiguration as specified in 5.3.5.13; (that is, add/mod/release, target cell monitoring, and execution)
The rest is the same and skipped
Write complete msg/perform RACH success
If reconfig withSync is included,
remove the rest except for a triggered entry from the existing UE Var and remove measId.
1. If the RRCReconfiguration message includes the conditionalReconfiguartion, and this is for conditional Reconfiguration execution:
2> perform conditional reconfiguration as specified in 5.3.5.13
Remove the triggered entry from the existing UE Var
)

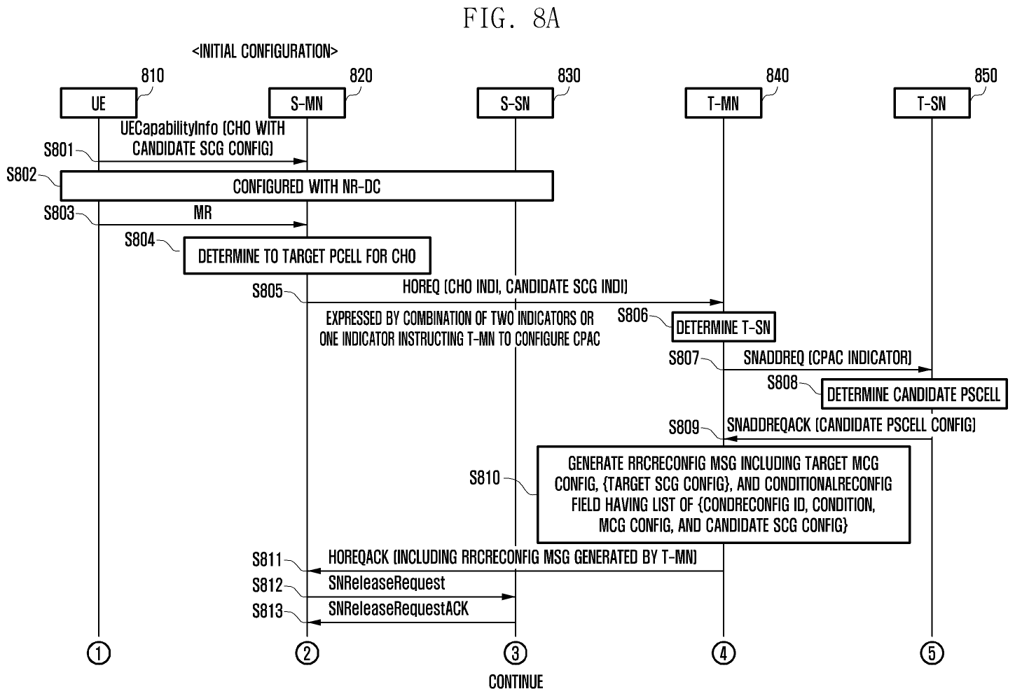

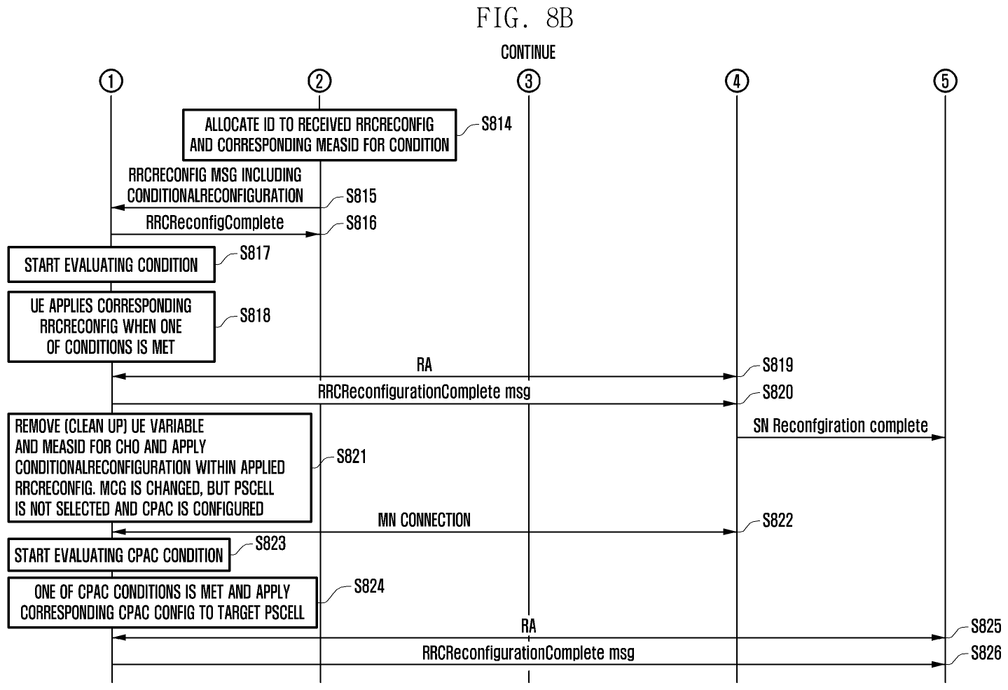

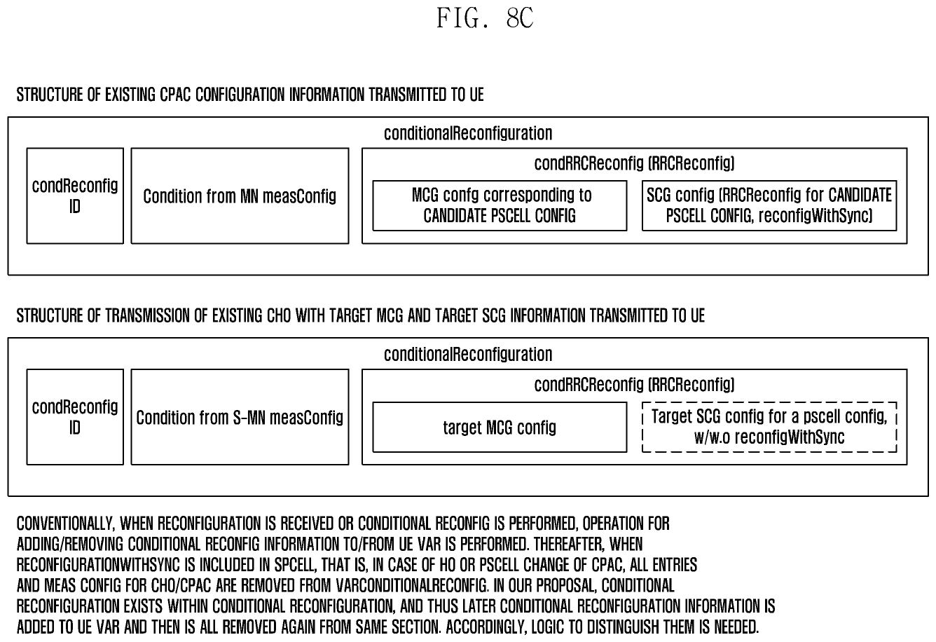

FIGS. 8A and 8B show an operation when the operation proposed in the disclosure is initially configured.

Referring to FIG. 8A, a UE 810 may transmit capability information which includes a multi-candidate SCG configuration and indicates that conditional handover is possible to an S-MN 820 in S801. Thereafter, through dual connection, the S-SN 820 may be configured for the UE 810 in S802. The UE measures the quality of a signal and transmits the corresponding measurement result to the S-MN 820 in S803, and the S-MN 820 receiving the same determines a target PCell in S804 and then transmits an HOReq message to a corresponding T-MN 840 in S805. At this time, the handover request message may include an indicator indicating the operation of the candidate SCG configuration along with a conditional handover indicator. The S-MN 820 may instruct the T-MN 840 to perform a CPAC configuration by using a combination of the two indicators or the latter indicator (candidate SCG-related indication) only.

The T-MN 840 receiving the handover request message may determine a T-SN 850, insert a CPAC indicator, an indicator that makes a request for changing a conditional PSCell, or an indicator that makes a request for configuring conditional CHO+CPC into an SNAddReq message, and transmit the SNAddReq message to the corresponding T-SN 850 in S807. At this time, for the T-SN, multiple SNs may be selected as candidate SNs. Each candidate SN 850 may determine its own PSCell in response to the SNAddReq message in S808 and transfer information on the corresponding PSCell (PSCell PCI, frequency) and configuration information (candidate SCG configuration information) to the T-MN 840 through an SNAddReqACK message in S809.

The T-MN 840 receiving the information groups the received candidate SCG configuration information, MCG configuration information reflecting the corresponding SCG configuration information (that is, MCG configuration information), and a condition to be met for the application of each candidate SCG (PSCell) determined by the T-MN 840 by one condReconfig ID and stores multiple lists in the conditional reconfiguration field. The condition information may include at least one piece of the following information.
Among RRM report configurations for the condition, information indicating A3 and/or A4, and/or A5 that are events used for comparing radio signal-based inter-cell sizes, or an event of B1 or B2 for comparing inter-RAT cell sizes,
Further/alternatively, as parameter information required for an indicated event for information indicating each event,
   In the case of A4 or B1, reference signal received power (RSRP)/reference signal received quality (RSRQ)/reference signal strength indicator (RSSI) value as a threshold value for a measurement value of the corresponding candidate PSCell
   In the case of A3, RSRP/RSRQ/RSSI value as a difference offset value between measurement values of the current PSCell of the UE and the corresponding candidate PSCell
   In the case of A5 or B2, RSRP/RSRQ/RSSI value as a threshold value for a measurement value of the current PSCell and a measurement value of the corresponding candidate PSCell

Additionally, when the current conditional handover is performed, configuration information for the target PCell, that is, the target MCG configuration information and the target SCG configuration information to be directly applied along with the corresponding target MCG are all combined and made as one RRCReconfiguration message. At this time, the condition information may be included in an Xn field separated from the target MCG and target SCG configuration information or an RRC field, and may be transferred from the T-MN 840 to the S-MN 850 in S810.

The T-MN 840 transfers the RRCReconfiguration message and/or the condition-related information to the S-MN 820 through an HOReqACK message in S811. Thereafter, signaling for SN release may be transmitted and received between the S-MN 8420 and the S-SN in S812 and S813.

For the received RRCReconfiguration message or a pair of the received specific target MCG configuration information and SCG configuration information, the S-MN 820 receiving the same may generate a condition for the corresponding MCG application. The condition for the corresponding MCG application, the condition for applying the SCG configuration in the pair, and the RRCReconfiguration corresponding to the pair of MCG and SCG configurations may be grouped by the condReconfig Id in S814, and the list is configured as each entry in the conditional reconfiguration field and transferred to the UE 810. At this time, the message may use the RRCReconfiguration message made by the S-MN in S815.

The condition for applying the SCG configuration in the pair may be determined by the S-MN 820 in consideration of condition information corresponding to the specific SCG transferred from the T-MN 840. For example, when the T-MN 840 transfers event type A4 and/or a threshold value for the specific SCG to the S-MN 820, the S-MN 820 may configure a frequency of a PSCell that means the corresponding SCG as a measurement object in its own measurement configuration, configure an event type transferred from the S-MN 820 as conditional event A4 in its own reportConfiguration, and transfer the same to the UE 810.

The UE 810 receiving the same stores an id included in an external conditional reconfiguration, a condition, and condRRCReconfig (that is, RRCReconfiguration message of each entry) in a UE variable, performs measurement corresponding to the condition, and starts conditional evaluation. If the specific condition is met, the UE 810 applies condRRCReconfig (RRCReconfiguration) associated with the corresponding condition in S818. During the process, the UE 810 follows one of the RRC configuration application schemes (opt 1, 2, and 3) described with reference to FIG. 7.

After performing RA to the corresponding MCG based on the target MCG associated with the met condition, that is, the T-MN 840 operating the PSCell in S819, the UE 810 transmits an RRCReconfigurationComplete message to the T-MN 840 and informs of target MCG configuration completion in S820. When the RRCReconfiguration application is completed, the UE stores configurations of candidate SCGs based on the target MCG in the UE variable while storing the internal conditional reconfiguration in the UE variable in S821, and starts measurement for the condition corresponding to each candidate SCG, based on measurement information configured by the corresponding T-MN 840 and starts evaluating the condition in S823 (start CPAC evaluation). Thereafter, when one of the evaluated CPAC conditions is met, an operation of applying the corresponding candidate SCG is performed in S824. The UE 810 may transmit an RRC reconfiguration complete message after performing RA with the candidate SCG that satisfies the condition in S825 and S826.

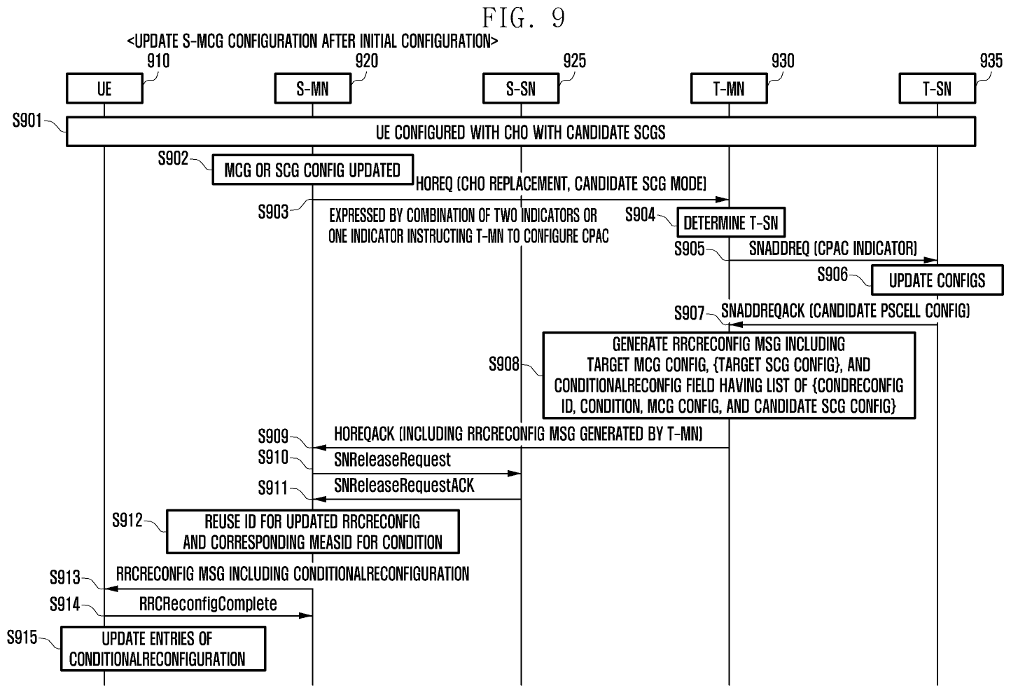

FIG. 9 is a diagram illustrating a procedure of, when a change in the current MCG configuration of an S-MN is made after conditional handover for a candidate SCG is initially configured in the UE, reflecting the corresponding configuration in CHO with candidate SCG configuration.

When a change in a configuration of a source MCG is needed in S902 after a UE 910 initially receives CHO with candidate SCG configuration in S901, a corresponding S-MN 920 transfers an HOReq message including an indicator indicating that candidate SCG configuration information should be modified to a T-MN 930. The T-MN 930 receiving the same may transfer an SNAddReq message including a CPAC update indicator to T-SNs 935 corresponding to the existing maintained candidate SCG, the T-SM 935 receiving the same may update the candidate SCG configuration based on the existing S-MCG configuration in S906 and transfer the candidate SCG configuration to the T-MN 930 in S907, and the T-MN 930 may transfer the candidate SCG configuration to the S-MN 920 in S909 and thus the S-MN 920 may finally indicate to modify an RRCReconfiguration message including updated candidate SCG configuration information for each cond Reconfig ID maintained in the existing conditionalReconfiguration. At this time, for the updated configuration, the pre-allocated cond Reconfig ID may be reused in S912. Thereafter, the S-MN 920 transmits an RRC reconfiguration message including the updated configuration to the UE 910, and the UE 910 transmits an RRC reconfiguration complete message to the S-MN 920 after applying the updated configuration in S914. Accordingly, entries of the conditional reconfiguration may be updated in the UE 910 in S915.

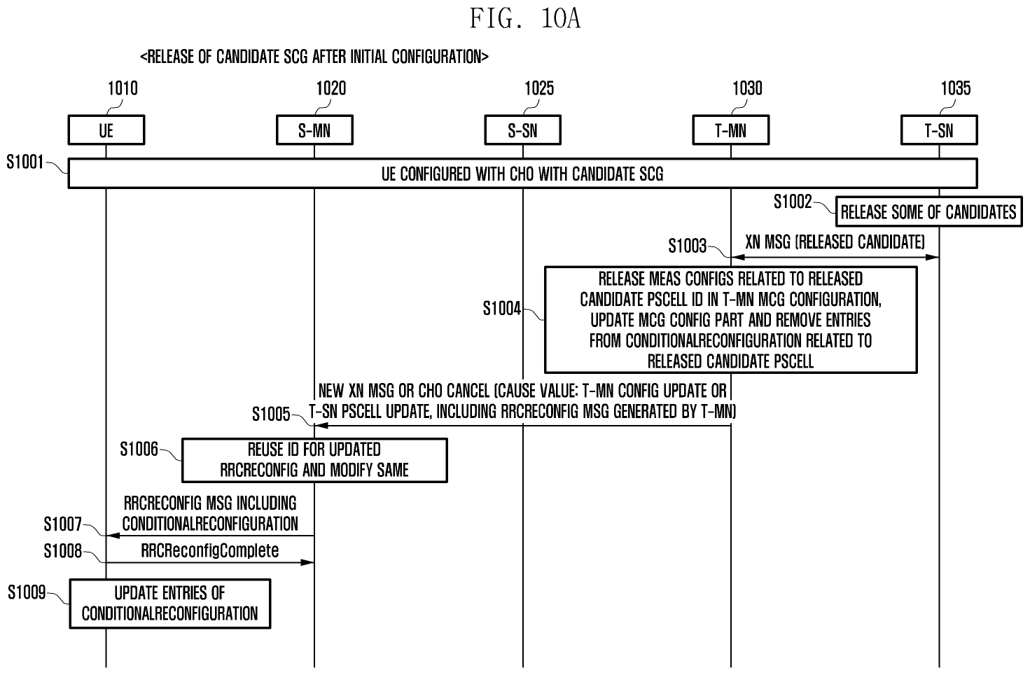

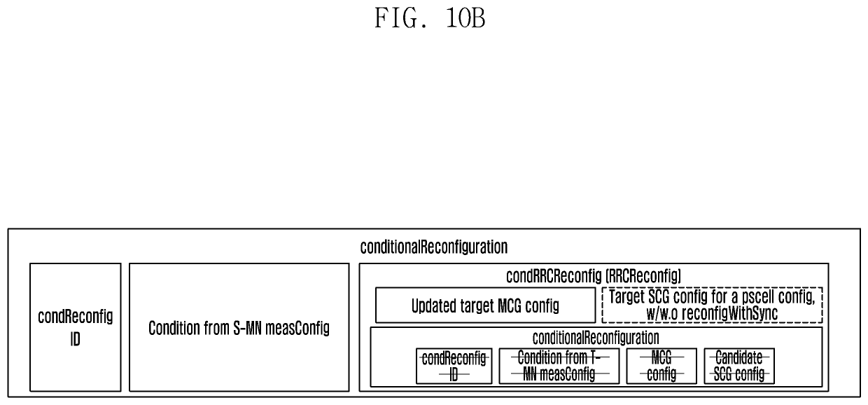

FIGS. 10A and 10B are diagrams illustrating a required procedure when a T-SN desires to release the maintained candidate SCG after Cho with candidate SCG is initially configured.

Referring to FIG. 10A, for a UE 1010, CHO including a candidate SCG (to which a CPAC operation is also applied) may be configured in S1001. At this time, a T-SN 1035 may determine to release a specific candidate SCG if desired in S1002. In this case, the T-SN 1035 may transfer the candidate SCG or candidate PSCell ID (PCI, and/or CGI) information to a T-MN 1030 through an Xn message in S1003. The T-MN 1030 receiving the information may remove an entry including the corresponding candidate SCG from an internal conditional reconfiguration, release an unnecessary measurement configuration from the pre-configuration, and include the same in a target MCG config in S1004. Further, the T-MN 1030 may reflect the changed configuration to generate an RRCREconfiguration message and transfer the RRCREconfiguration message to the S-MN 1020 in S1005. At this time, the T-MN 1030 may also include an indicator indicating the release of the candidate SCG or the change in the target MCG configuration by a cause value in the generated RRCREconfiguration message and transfer the RRCREconfiguration message to the S-MN 1020. After receiving the same, the S-MN 1020 transfers the changed RRCReconfiguration message to a cond Reconfig ID entry corresponding to the changed RRCReconfiguration message as illustrated in FIG. 10B. The UE 1010 overwrites the newly received RRCReconfiguration message in the entry of the corresponding condReconfig ID in S1009.

FIG. 11 illustrates operations performed by the UE and the order thereof when RRCReconfiguration is currently received, and the problematic parts in that case.

The left part means RRC standard clauses 5.3.5.3, that is, the UE operation when RRCReconfiguration is received. This content is the same as previously mentioned, but is more abbreviated than the following steps (step 1 is omitted in the following content).
1) Apply specific configuration
2) Identify whether a conditional reconfiguration is included in RRCReconfiguration and, when it is included, perform a given conditional reconfiguration entry add/modification/release operation for a UE variable and then start evaluating the corresponding condition, and when it is determined that the condition is met, jump back to the RRCReconfig performance operation step
3) Apply specific configuration
4) Write RRCReconfigurationComplete
5) Operate after RACH success
6) When the MCG or the SCG includes reconfiguration WithSync, remove all entries of the UE variable, remove reportconfig for the condition from measConfig of a source SPCell, also remove MO for only conditional Reconfig, and remove reportconfig for the condition and measId associated therewith

The right part of the figure illustrates the problematic part in the specific step.

Methods according to embodiments stated in the claims or specifications of the disclosure may be implemented in hardware, software, or a combination of hardware and software.

In the implementation of software, a computer-readable storage medium for storing one or more programs (software modules) may be provided. The one or more programs stored in the computer-readable storage medium may be configured for execution by one or more processors within the electronic device. The one or more programs may include instructions for allowing the electronic device to perform methods according to embodiments stated in the claims or specifications of the disclosure.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, the programs may be stored in a memory configured by a combination of some or all of the listed components. Further, the number of configured memories may be plural.

In addition, the programs may be stored in an attachable storage device which may access the electronic device through communication networks such as the Internet, an Intranet, a local area network (LAN), wide LAN (WLAN), and a storage area network (SAN) or a combination thereof. The storage device may access a device implementing embodiments of the disclosure through an external port. Further, a separate storage device in a communication network may access the device implementing embodiments of the disclosure.

In the above-described detailed embodiments, the number of elements included in the disclosure is expressed in the singular or the plural according to the presented detailed embodiment. However, the singular or plural expression is selected to be suitable for a presented situation for convenience of description, the disclosure is not limited to a singular component or plural components, and even components expressed in the plural form may be configured in the singular form or even components expressed in the singular form may be configured in the plural form.

Meanwhile, although the concrete embodiments of the disclosure have been described in the detailed description of the disclosure, various modifications can be made without departing from the scope of the disclosure. Therefore, the scope of the disclosure should not be defined as being limited to the embodiments, but should be defined by the appended claims and equivalents thereof.

1-15. (canceled)

16. A method performed by a first base station in a communication system, the method comprising:
transmitting, to a second base station, a handover request message including first information on a conditional handover (CHO) and second information indicating a candidate secondary cell group (SCG) configuration;
receiving, from the second base station, a handover request acknowledge message including a condition parameter of at least one candidate primary secondary cell (PSCell); and
transmitting, to a terminal, a radio resource control (RRC) message including conditional reconfiguration information for CHO candidate SCG configuration information.

17. The method of claim 16, wherein the conditional reconfiguration information for CHO and candidate SCG configuration information includes an execution condition for the CHO and an execution condition for a candidate PSCell.

18. The method of claim 17, wherein the conditional reconfiguration information for CHO and candidate SCG configuration includes a conditional reconfiguration identity (ID), and a configuration reconfiguration including a master cell group (MCG) configuration for the CHO and an SCG configuration for the candidate PSCell.

19. The method of claim 16, wherein the condition parameter is associated with an event A4 and includes a threshold for at least one of a reference signal received power (RSRP) or a reference signal received quality (RSRQ).

20. A method performed by a second base station in a communication system, the method comprising:
receiving, from a first base station, a handover request message including first information on a conditional handover (CHO) and second information indicating a candidate secondary cell group (SCG) configuration;
transmitting, to a third base station, a secondary node (SN) addition request message for requesting information on at least one candidate primary secondary cell (PSCell);
receiving, from the third base station, an SN addition request acknowledge message including the information on the at least one candidate PSCell; and
transmitting, to the first base station, a handover request acknowledge message including a condition parameter of at least one candidate PSCell.

21. The method of claim 20, wherein the information on the at least one candidate PSCell includes an identity (ID) for each of the at least one candidate PSCell and a configuration for the at least one candidate PSCell.

22. The method of claim 20, wherein the condition parameter is associated with an event A4 and includes a threshold for at least one of a reference signal received power (RSRP) or a reference signal received quality (RSRQ).

23. A first base station in a communication system, the first base station comprising:
a transceiver; and
a controller configured to:
control the transceiver to transmit, to a second base station, a handover request message including first information on a conditional handover (CHO) and second information indicating a candidate secondary cell group (SCG) configuration,
control the transceiver to receive, from the second base station, a handover request acknowledge message including a condition parameter of at least one candidate primary secondary cell (PSCell), and
control the transceiver to transmit, to a terminal, a radio resource control (RRC) message including conditional reconfiguration information for CHO candidate SCG configuration information.

24. The first base station of claim 23, wherein the conditional reconfiguration information for CHO and candidate SCG configuration information includes an execution condition for the CHO and an execution condition for a candidate PSCell.

25. The first base station of claim 24, wherein the conditional reconfiguration information for CHO and candidate SCG configuration includes a conditional reconfiguration identity (ID), and a configuration reconfiguration including a master cell group (MCG) configuration for the CHO and an SCG configuration for the candidate PSCell.

26. The first base station of claim 25, wherein the condition parameter is associated with an event A4 and includes a threshold for at least one of a reference signal received power (RSRP) or a reference signal received quality (RSRQ).

27. A second base station in a communication system, the second base station comprising:
a transceiver; and
a controller configured to:
control the transceiver to receive, from a first base station, a handover request message including first information on a conditional handover (CHO) and second information indicating a candidate secondary cell group (SCG) configuration,
control the transceiver to transmit, to a third base station, a secondary node (SN) addition request message for requesting information on at least one candidate primary secondary cell (PSCell),
control the transceiver to receive, from the third base station, an SN addition request acknowledge message including the information on the at least one candidate PSCell, and
control the transceiver to transmit, to the first base station, a handover request acknowledge message including a condition parameter of at least one candidate PSCell.

28. The second base station of claim 27, wherein the information on the at least one candidate PSCell includes an identity (ID) for each of the at least one candidate PSCell and a configuration for the at least one candidate PSCell.

29. The second base station of claim 27, wherein the condition parameter is associated with an event A4 and includes a threshold for at least one of a reference signal received power (RSRP) or a reference signal received quality (RSRQ).
